(19) United States
(12) Patent Application Publication
(10) Pub. No.: US 2014/0346963 A1
(43) Pub. Date: Nov. 27, 2014

(54) LIGHT SOURCE DRIVING APPARATUS AND LIGHT SOURCE SYSTEM

(71) Applicant: SAMSUNG ELECTRONICS CO., LTD., Suwon-si (KR)

(72) Inventor: Shin Ho KANG, Incheon (KR)

(73) Assignee: SAMSUNG ELECTRONICS CO., LTD., Suwon-si (KR)

(21) Appl. No.: 14/135,135

(22) Filed: Dec. 19, 2013

(30) Foreign Application Priority Data
May 27, 2013 (KR) 10-2013-0059940

(51) Int. Cl. H05B 33/08

(52) U.S. Cl. CPC H05B 33/0818
USPC 315/200 R; 315/307

(57) ABSTRACT

A light source driving apparatus includes a triac configured to control a phase of an output voltage, a diac connected to a gate of the triac and configured to apply a trigger signal, a voltage charger configured to provide a breakover voltage to the diac, a variable resistor unit configured to determine a point in time at which the voltage charger provides a breakover voltage, and a variable impedance unit connected to both ends of the triac. The variable impedance unit includes a capacitor and an inductor, and is configured to vary impedance of the variable impedance unit.

### CROSS-REFERENCE TO RELATED APPLICATION

This application claims benefit of priority to Korean Patent Application No. 10-2013-0059940 filed on May 27, 2013, with the Korean Intellectual Property Office, the entire contents of which are hereby incorporated by reference.

### TECHNICAL FIELD

The present inventive concept relates to a light source driving apparatus and a light source system.

### BACKGROUND

Compared with filament-based light emitting devices, light emitting diodes (LEDs) have various advantages such as a long lifespan, low power consumption, excellent initial driving characteristics, high vibration resistance, and the like. Thus, demand for LEDs continues to grow. Meanwhile, light source devices using LEDs have properties different from those of conventional light bulbs (or incandescent lamps) having resistive load characteristics, in that when such a light source device using LEDs is applied to a driving device based on a phase control scheme, the light source device may not be properly operated or a flicker phenomenon may occur, degrading optical quality. Thus, in the art, a method for securing compatibility between a light source device using LEDs and a driving device using a phase control scheme is required.

### SUMMARY

An aspect of the present inventive concept provides a light source driving apparatus highly compatible with a light source device including a light emitting diode (LED).

An aspect of the present inventive concept provides a light source system having a reduced flicker phenomenon and improved compatibility between a light source device including an LED and a light source driving apparatus.

However, objects of the present inventive concept are not limited thereto and objects and effects that may be recognized from technical solutions or embodiments described hereinafter may also be included although not explicitly mentioned.

One aspect of the present inventive concept relates to a light source driving apparatus including a triac configured to control a phase of an output voltage, a diac connected to a gate of the triac and configured to apply a trigger signal, a voltage charger configured to provide a breakover voltage to the diac, a variable resistor unit configured to determine a point in time at which the voltage charger provides a breakover voltage, and a variable impedance unit connected to both ends of the triac and including a capacitor and an inductor. The variable impedance unit is configured to vary the impedance of the variable impedance unit.

The variable impedance unit may include at least one capacitor and a first switch connected to the at least one capacitor in series, and at least one inductor and a second switch connected to the at least one inductor in parallel.

The variable impedance unit may include two or more capacitors, and at least one switch connected to the two or more capacitor in series, and two or more inductors, and two or more switches connected to the two or more inductors in parallel, respectively.

The light source driving apparatus may further include an impedance controller configured to detect impedance of the light source driving apparatus and a light source device connected to the light source driving apparatus, and vary impedance of the variable impedance unit.

The impedance controller may include an A/D converter configured to convert the detected impedance into a digital signal, and a control processing unit (CPU) configured to output a control signal for varying impedance of the variable impedance unit upon receiving the digital signal.

The first and second switches are switched ON/OFF based on the control signal outputted from the CPU.

When the detected impedance is lower than a pre-set value, the impedance controller may be configured to increase impedance of the variable impedance unit. When the detected impedance is higher than the pre-set value, the impedance controller may be configured to reduce impedance of the variable impedance unit.

The variable impedance unit may include a plurality of capacitors connected in parallel and a plurality of switches connected to the plurality of capacitors in series, respectively.

The variable impedance unit may include a plurality of inductors connected in series and a plurality of switches connected to the plurality of inductors in parallel, respectively.

The variable resistor unit may include a fixed resistor element, and a variable resistor element connected to the fixed resistor element in series.

The variable resistor unit may include a dimming removal switch connected to the variable resistor element in parallel.

Another aspect of the present inventive concept encompasses a light source system including a light source device including a light emitting diode (LED), and a light source driving apparatus configured to provide a phase-controlled voltage to the light source device, and vary impedance of the light source driving apparatus by changing at least one of capacitance and inductance.

The light source driving apparatus may include a variable impedance unit including at least one capacitor and a switch connected to the at least one capacitor in series, and at least one inductor and a switch connected to the at least one inductor in parallel.

The light source driving apparatus may further include an impedance controller configured to detect impedance of the light source driving apparatus and the light source device, and vary impedance of the variable impedance unit.

When the detected impedance is lower than a pre-set value, the impedance controller may be configured to increase impedance of the variable impedance unit. When the detected impedance is higher than the pre-set value, the impedance controller may be configured to reduce impedance of the variable impedance unit.

The light source device may include a rectifier configured to rectify a phase-controlled voltage provided from the light source driving apparatus, a DC/DC converter configured to convert a magnitude of the rectified voltage, and a light emitting diode (LED) driven by a voltage having the converted magnitude.

Still another aspect of the present inventive concept relates to a light source driving apparatus including a triac configured to control a phase of an output voltage, and a variable impedance unit connected to both ends of the triac. The variable impedance unit includes two or more capacitors, and at least one switch connected to the two or more capacitors in series, and two or more inductors, and two or more switches connected to the two or more inductors in parallel, respectively. The variable impedance unit is configured to vary impedance of the variable impedance unit.

The light source driving apparatus may further include a diac connected to a gate of the triac and configured to apply a trigger signal. The triac may be turned on, upon receiving the trigger signal from the gate of the triac, and then power from an external power source may be applied to a light source device through the triac.

The light source driving apparatus may further include a voltage charger configured to provide a breakover voltage to the diac.

The light source driving apparatus may further include a variable resistor unit configured to determine a point in time at which the voltage charger provides a breakover voltage.

The foregoing technical solutions do not fully enumerate all of the features of the present inventive concept. The foregoing and other objects, features, aspects and advantages of the present inventive concept will become more apparent from the following detailed description of the present inventive concept when taken in conjunction with the accompanying drawings.

### BRIEF DESCRIPTION OF THE DRAWINGS

The above and other aspects, features and other advantages of the present inventive concept will be more clearly understood from the following detailed description taken in conjunction with the accompanying drawings, in which like reference characters may refer to the same or similar parts throughout the different views. The drawings are not necessarily to scale, emphasis instead being placed upon illustrating the principles of the embodiments of the inventive concept. In the drawings, the thickness of layers and regions may be exaggerated for clarity.

FIG. 1 is a circuit diagram illustrating a light source driving apparatus and a light source system according to an embodiment of the present inventive concept.

FIGS. 2A through 2C are views illustrating voltage waveforms schematically representing operations of the light source driving apparatus according to an embodiment of the present inventive concept.

FIG. 3 is a circuit diagram illustrating a light source driving apparatus and a light source system according to a modification to the embodiment of FIG. 1.

FIG. 4 is a circuit diagram illustrating a light source driving apparatus according to a modification to the embodiment of FIG. 1.

FIG. 5 is a circuit diagram illustrating a light source driving apparatus and a light source system according to another embodiment of the present inventive concept;

FIG. 6 is a circuit diagram illustrating a light source driving apparatus and a light source system according to a modification to the embodiment of FIG. 5.

FIGS. 7 and 8 are exploded perspective views illustrating light source devices employable in a light source system according to an embodiment of the present inventive concept.

### DETAILED DESCRIPTION

Hereinafter, embodiments of the present inventive concept will now be described in detail with reference to the accompanying drawings.

The present inventive concept may, however, be embodied in many different forms and should not be construed as being limited to the embodiments set forth herein. Rather, these embodiments of the present inventive concept are provided so that this disclosure will be thorough and complete, and will fully convey the scope of the present inventive concept to those skilled in the art. In the drawings, the shapes and dimensions of elements may be exaggerated for clarity, and the same reference numerals will be used throughout to designate the same or like components.

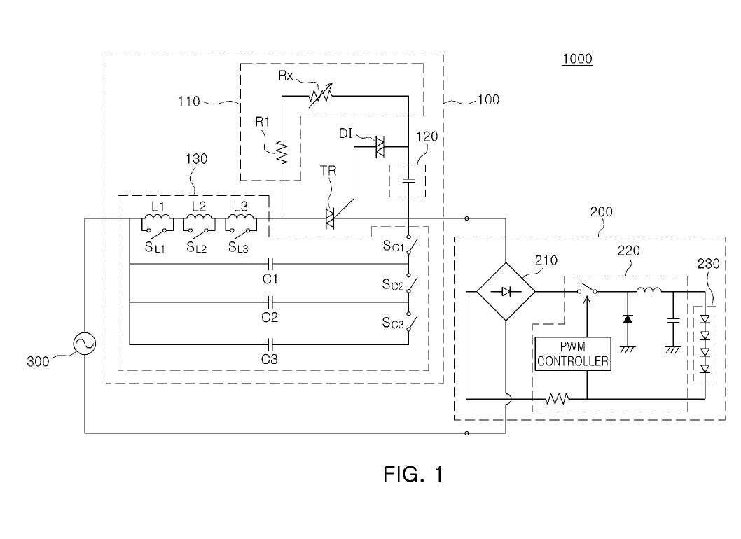

FIG. 1 is a circuit diagram illustrating a light source driving apparatus 100 and a light source system 1000 according to an embodiment of the present inventive concept.

Referring to FIG. 1, the light source system 1000 according to an embodiment of the present inventive concept may include a light source device 200 including a light emitting diode (LED), and a light source driving apparatus 100 applying driving power to the light source device 200.

The light source driving apparatus 100 may receive power from an external power source 300 and output the received power to the light source device 200. Here, the light source driving apparatus 100 may control a phase of the output voltage to allow for dimming control of the light source device 200.

To this end, the light source driving apparatus 100 may include a triac TR that controls a phase of the output voltage and a diac DI connected to a gate of the triac TR. The diac DI may be provided with a breakover voltage from a voltage charger 120, and a point in time at which the voltage charger 120 provides the breakover voltage may be determined by a variable resistor unit 110.

In an embodiment of the present inventive concept, the variable resistor unit 110 may include a fixed resistor element R1, e.g., a resistor, and a variable resistor element Rx, e.g., a resistor, connected to the fixed resistor element R1 in series, but the present inventive concept is not limited thereto. Also, the voltage charger 120 may include a capacitive element, e.g., a capacitor.

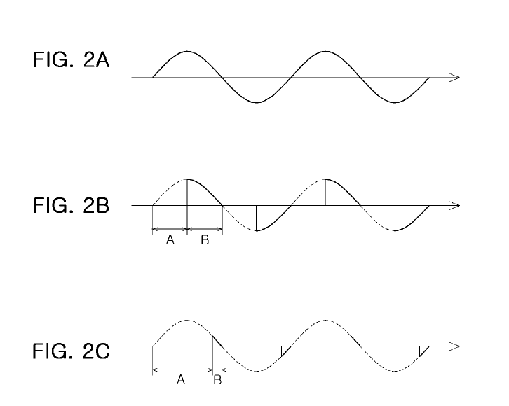

Specific operations will be described with reference to FIG. 2.

The external power source 300 may provide alternating current (AC) power having a predetermined frequency. A voltage waveform applied by the external power source 300 may be the same as illustrated in FIG. 2A. When the triac TR is in an OFF state, the external power source 300 may be cut off by the triac TR so power cannot be applied to the light source device 200. When the triac TR is turned on upon receiving a trigger signal from the gate thereof, power from the external power source 300 may be applied to the light source device 200 through the triac TR. A voltage applied to the light source device 200 may have a waveform such as that illustrated in FIG. 2B. Here, by controlling a point in time at which the triac TR is turned on, a magnitude of power from the external power source 300 applied to the light source device 200 may be regulated, whereby dimming of the light source device 200 may be controlled.

In detail, the triac TR may receive a trigger signal from the diac DI connected to the gate of the triac TR, and the diac DI may receive a voltage (breakover voltage) from the voltage charger 120 having a predetermined magnitude or greater, forming a channel in which a current flows. Thus, a point in time at which the triac TR is turned on may be determined based on a point in time at which the diac DI is provided with a breakover voltage.

Here, the voltage charger 120 may charge a voltage applied from the external power source 300 to reach the breakover voltage, and a time required for the voltage charger 120 to reach the breakover voltage may be controlled by adjusting the resistance of the variable resistor unit 110. Namely, the variable resistor unit 110 may be connected to the voltage charger 120 in series to control the magnitude of the voltage of the external power 300 applied to the voltage charger 120 according to the principle of voltage distribution.

Here, if the resistance of the variable resistor unit 110 is adjusted to be low, the magnitude of the voltage of the external power source 300 applied to the voltage charger 120 increases to allow the voltage charger 120 to reach the breakover voltage earlier. Accordingly, the diac DI forms a channel allowing for a current flow to apply a trigger signal to the gate of the triac TR, and thus, the triac TR is turned on. Conversely, when resistance increases in the variable resistor unit 110, the magnitude of the voltage from the external power source 300, applied to the voltage charger 120, is reduced, making the voltage charger 120 reach the breakover voltage later. Thus, as illustrated in FIG. 2C, a point in time at which the triac TR is turned on comes late, reducing the magnitude of power applied to the light source device 200.

Meanwhile, the light source driving apparatus based on a phase control scheme is not compatible with a light source device including an LED. In detail, when the light source driving apparatus based on a phase control scheme is applied to the foregoing light source device, a flicker phenomenon occurs, degrading optical quality thereof, which mainly results from electrical characteristics of the LED.

In detail, in order for the light source driving apparatus based on a phase control scheme to be smoothly operated, a holding current should be provided to the triac TR, and in this case, since the LED has a threshold voltage, an output voltage having a low conduction angle such as the voltage waveform illustrated in FIG. 2(c) may cause disconnection of circuits, and thus, the flow of the holding current to the triac TR may be cut off.

Also, a general light bulb (e.g., an incandescent lamp) has rated power large enough to supply a sufficient holding current to the triac TR. However, the light source device having an LED as a light source may have rated power too small to supply a holding current to the triac TR.

In addition, unlike a light bulb having resistive load characteristics, the light source device having an LED as a light source may have impedance load characteristics, and a voltage may be distorted due to a reactance component of an impedance load. Namely, the reactance component of the impedance load may cause a peak current in a phase cut region, e.g., in the boundary between regions A and B in FIGS. 2B and 2C, of the output voltage output from the triac TR. Such a peak current may have a current level higher than a current level allowed for the triac TR to cause malfunctioning of the triac TR.

In an embodiment of the present inventive concept, a scheme for addressing the foregoing problem by matching impedance between the light source driving apparatus 100 and the light source device 200 is proposed. To this end, the light source driving apparatus 100 according to an embodiment of the present inventive concept may include a variable impedance unit 130 connected to both ends of the triac TR and configured to vary impedance. By variously changing equivalent impedance of the light source driving apparatus 100 by using the variable impedance unit 130, compatibility between the light source device 200 and the light source driving apparatus 100 can be enhanced and degradations of optical quality can be prevented.

For example, when it is determined that a holding current required for the triac TR is not guaranteed due to the LED of the light source device 200 not being smoothly turned on due to an output voltage having a low conduction angle, the impedance of the variable impedance unit 130 may be reduced to lower the equivalent impedance of the light source driving apparatus 100. Accordingly, a proportion of the voltage applied to the light source device 200 may be increased, and an undesired disconnection of circuits can be prevented.

Also, by appropriately setting impedance of the variable impedance unit 130, a reactance component of the impedance of the light source device 200 and the light source driving apparatus 100 may be removed. Accordingly, malfunctions due to a peak current can be prevented. If necessary, the impedance of the variable impedance unit 130 may be increased to alleviate an inrush current having a level higher than a level allowed for the triac TR.

The variable impedance unit 130 may include at least one capacitor and at least one inductor, and may include at least one switch connected to each capacitor in series or connected to each inductor in parallel, but the present inventive concept is not limited thereto. Here, the switch may be a relay switch, for example.

In detail, as illustrated in FIG. 1, the impedance unit 130 according to an embodiment of the present inventive concept may include a plurality of capacitors C1, C2, and C3 connected in parallel and switches S_{C1}, S_{C2}, S_{C3} connected to the plurality of capacitors C1, C2, and C3 in series, respectively. The variable impedance unit 130 further may include a plurality of inductors L1, L2, and L3 connected in series and switches S_{L1}, S_{L2}, S_{L3} connected to the plurality of inductors L1, L2, and L3 in parallel, respectively. Here, the overall capacitance and inductance may vary according to an operation of switching the switches S_{L1}, S_{L2}, S_{L3}, S_{C1}, S_{C2}, and S_{C3} on or off, and accordingly, the impedance of the variable impedance unit 130 may be changed. Namely, in an embodiment of the present inventive concept, the light source driving apparatus 100 may provide a phase-controlled voltage to the light source device 200 and the equivalent impedance of the light source driving apparatus 100 may be changed as at least one of capacitance and inductance is varied.

In the embodiment illustrated in FIG. 1, when the variable impedance unit 130 includes three inductors L1, L2, and L3 and three switches S_{L1}, S_{L2}, and S_{L3} connected to the inductors L1, L2, and L3 in parallel, respectively, an overall impedance value Z_{Lt} of the inductors L1, L2, and L3 that may be obtained by regulating the switches S_{L1}, S_{L2}, and S_{L3} connected to the inductors L1, L2, and L3, respectively, may be organized as shown in Table 1 below. In Table 1, ‘1’ indicates that the switches are turned on, and ‘0’ indicates that the switches are turned off.

TABLE 1

| Case | | | | Overall | |
|---|---|---|---|---|---|
| Number | S_{L1} | S_{L2} | S_{L3} | inductance (Lₜ) | Impedance (Z_{Lt}) |
| 1 | 1 | 1 | 1 | 0 | 0 |
| 2 | 0 | 1 | 1 | L1 | jwL1 |
| 3 | 1 | 0 | 1 | L2 | jwL2 |
| 4 | 1 | 1 | 0 | L3 | jwL3 |
| 5 | 0 | 0 | 1 | L1 + L2 | jw(L1 + L2) |
| 6 | 0 | 1 | 0 | L1 + L3 | jw(L1 + L3) |
| 7 | 1 | 0 | 0 | L2 + L3 | jw(L2 + L3) |
| 8 | 0 | 0 | 0 | L1 + L2 + L3 | jw(L1 + L2 + L3) |

In addition, when the variable impedance unit 130 includes the three capacitors C1, C2, and C3 and the three switches S_{C1}, S_{C2}, and S_{C3} connected to the capacitors C¹, C², and C3 in series, respectively, overall impedance Z_{Ct} of the capacitors C1, C2, and C3 that may be obtained by regulating the switches S_{C1}, S_{C2}, and S_{C3} connected to the capacitors C1, C2, and C3 are organized as shown in Table 2 below.

TABLE 2

| Case | | | | Overall | |
|---|---|---|---|---|---|
| Number | S_{C1} | S_{C2} | S_{C3} | capacitance (Cₜ) | Impedance (Z_{Ct}) |
| 1 | 0 | 0 | 0 | 0 | 0 |
| 2 | 1 | 0 | 0 | C1 | $\frac{1}{j wC 1}$ |
| 3 | 1 | 1 | 0 | C1 + C2 | $\frac{1}{j w ( C 1 + C 2 )}$ |
| 4 | 1 | 1 | 1 | C1 + C2 + C3 | $\frac{1}{j w ( C 1 + C 2 + C 3 )}$ |

Namely, by appropriately switching on or off the switches S_{L1}, S_{L2}, and S_{L3} connected to the inductors L1, L2, and L3 and the switches S_{C1}, S_{C2}, and S_{C3} connected to the capacitors C1, C2, and C3, the variable impedance unit 130 may have a maximum of thirty-two different impedance values. Based on this, the light source driving apparatus 100 may be appropriately varied to have the most appropriate impedance value.

Of course, various amounts of inductors and capacitors may be provided, and the amount of the inductors and the amount of the capacitors may be different. For example, when the variable impedance unit 130 includes N (N is a natural number equal to or greater than 1) number of inductors connected in series and N number of switches connected to the inductors in parallel, respectively, maximum variable impedance values by turning the switches connected to the inductors on and off may be 2^{N}. Also, when the variable impedance unit 130 includes M (M is a natural number equal to or greater than 1) number of capacitors connected in parallel and M number of switches connected to the capacitors in series, respectively, a maximum variable impedance values by turning the switches connected to the capacitors on and off may be (M+1). Thus, when the variable impedance unit 130 includes N number of inductors and switches and M number of capacitors and switches, the variable impedance unit 130 may have a maximum of 2^{N}(M+1) impedance values.

Meanwhile, in consideration of convenience of impedance calculation, it is described that the inductors L1, L2, and L3 are connected in series and the capacitors C1, C2, and C3 are connected in parallel, but the present inventive concept is not limited thereto. Namely, the inductors L1, L2, and L3 may be connected in parallel and the capacitors C1, C2, and C3 may be connected in series.

Hereinafter, the light source device 200, and another element of the light source system 200 will be described.

The light source device 200 may include LEDs as a light source. The LEDs may be provided as a light emitting array 230 in which a plurality of LEDs are connected in series.

Each LED may be a type of semiconductor device that emits light when power is applied thereto, for example. The light source device 200 may include a rectifier 210 rectifying a phase-controlled voltage provided from the light source driving apparatus 100. Also, the light source device 200 may include a DC/DC converter 220 modulating a magnitude of the rectified voltage. In the embodiment of FIG. 1, the DC/DC converter 220, which modulates a magnitude of the voltage rectified through a pulse width modulation (PWM) controller is illustrated as a buck-type DC/DC converter, for example, but the present inventive concept is not limited thereto and the DC/DC converter 220 may also be implemented as a boost-type DC/DC converter or a buck-boost-type DC/DC converter.

According to an embodiment of the present inventive concept, the light source driving apparatus 100, highly compatible with the light source device 200 including LEDs, can be realized, and the light source system 1000 having a reduced flicker phenomenon and improved optical qualities can be attained.

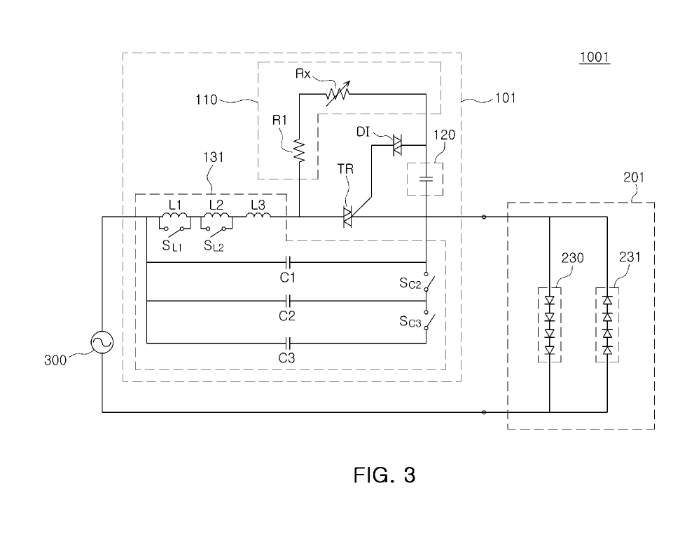

FIG. 3 is a circuit diagram illustrating the light source driving apparatus 101 and the light source system 1001 according to a modification to the embodiment of FIG. 1.

Referring to FIG. 3, the light source system 1001 according to an embodiment of the present inventive concept may include a light source device 201 including LEDs and a light source driving apparatus 101 providing a phase-controlled voltage to the light source device 201. In the light source driving apparatus 101, at least one of capacitance and inductance may be changed to vary equivalent impedance.

The light source driving apparatus 101 may include a variable impedance unit 131 that includes capacitors C1, C2, and C3 and inductors L1, L2, and L3 and has varied impedance. Hereinafter, descriptions of the same elements as those of the embodiment described above with reference to FIG. 1 will be omitted, and only different elements will be described.

In an embodiment of the present inventive concept, the variable impedance unit 131 may include a plurality of capacitors C1, C2, and C3, switches S_{C2} and S_{C3} connected to the capacitors in series, respectively, and a plurality of inductors L1, L2, and L3, and switches S_{L1} and S_{L2} connected to the inductors in parallel, respectively.

Here, at least one of the plurality of capacitors C1, C2, and C3 may be a fixed capacitor C1 which is not connected to a switch in series and provides constant capacitance. Also, at least one of the plurality of inductors L1, L2, and L3 may be a fixed inductor L3 which is not connected to a switch in parallel and provides constant inductance.

Namely, the variable impedance unit 131 may include the fixedly inserted inductor L3 and the capacitor C1, and in this case, the variable impedance unit 131 may serve as an LC filter that reduces electromagnetic interference (EMI) in an output voltage regardless of ON/OFF control of the switches S_{L1}, S_{L2}, S_{C2}, and S_{C3}.

Thus, according to an embodiment of the present inventive concept, the light source driving apparatus 101 may be able to output a more stable voltage to the light source device 201 and optical qualities of the light source system 1001 can be further improved.

In an embodiment of the present inventive concept, the light source device 201 may include first LEDs, and further include second LEDs connected to the first LEDs in parallel in a reverse polarity manner. In detail, the light source device 201 according to an embodiment of the present inventive concept may include a light emitting array 230 including a plurality of LEDs connected in series and a reverse polarity array 231 including at least one LED connected in parallel to the light emitting array 230 in a reverse polarity manner. In this case, the light source device 201 may be directly driven by alternating current (AC) power, eliminating the necessity of the rectifier, and thus, a size and manufacturing cost of the device can be advantageously reduced.

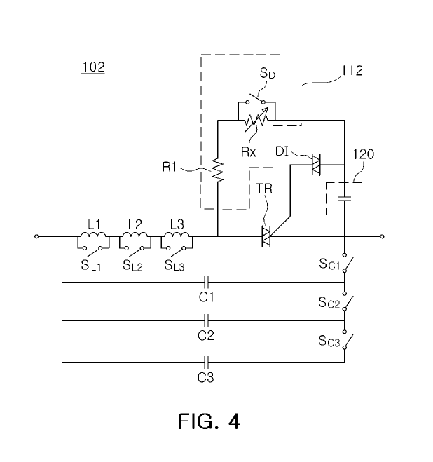

FIG. 4 is a circuit diagram illustrating a light source driving apparatus 102 according to a modification to the embodiment of FIG. 1. For the description purpose, only a circuit diagram of the light source driving apparatus 102 is illustrated, but the light source driving apparatus 102 described herein may also be employed in the light source system 1000, 1001, 1002 and 1003 according to an embodiment of the present inventive concept.

Referring to FIG. 4, the light source driving apparatus 102 according to an embodiment of the present inventive concept may include a variable resistor unit 112. The variable resistor unit 112 may include a fixed resistor element R1 and a variable resistor element Rx connected to the fixed resistor element R1 in series. Here, the variable resistor unit 112 may include a dimming removal switch S_{D} connected to the variable resistor element Rx in parallel.

In an embodiment of the present inventive concept, when the dimming removal switch S_{D} is set to be switched off, a phase of a voltage output by the triac TR may be controlled by adjusting resistance, and when the dimming removal switch S_{D} is set to be switched on, the triac TR may output a constant output voltage to the light source device 200 or 201, irrespective of fluctuation of resistance of the variable resistor element Rx.

Namely, by setting an ON/OFF operation of the dimming removal switch S_{D}, a dimming function of the light source system 1000, 1001, 1002 or 1003 may be controlled not to be operated. When a flicker phenomenon in the light source device 200 or 201 occurs severely, a dimming function may be controlled not to be operated as necessary to secure stable optical qualities in the light source device 200 or 201.

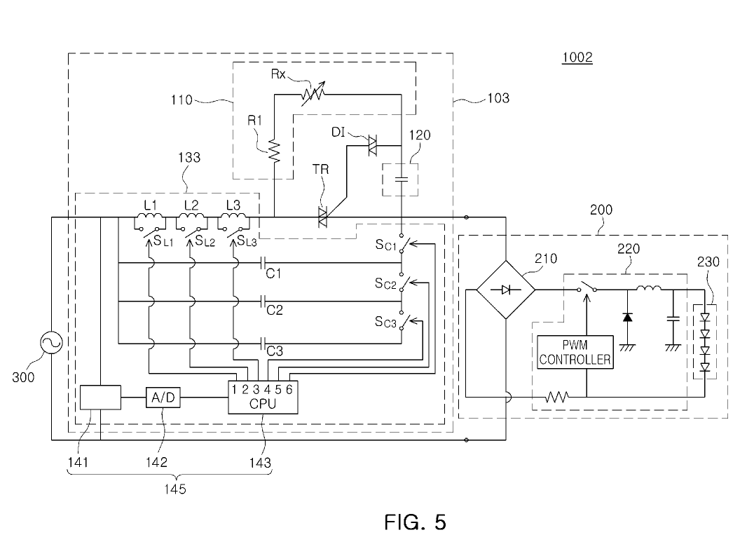

FIG. 5 is a circuit diagram illustrating a light source driving apparatus 103 and a light source system 1002 according to another embodiment of the present inventive concept.

Referring to FIG. 5, a light source system 1002 may include a light source device 200 including LEDs and a light source driving apparatus 103 applying driving power to the light source device 200.

In an embodiment of the present inventive concept, the light source driving apparatus 103 may further include an impedance controller 145. The impedance controller 145 may detect impedance of the light source driving apparatus 103 and the light source device 200 and vary the impedance of the variable impedance unit 133 such that the light source driving apparatus 103 may have appropriate impedance.

In detail, when the detected impedance is higher than a pre-set value, the impedance controller 145 may reduce the impedance of the variable impedance unit 133 such that a proportion of a voltage applied to the light source device 200 is larger than a proportion of the voltage applied to the light source driving apparatus 103, thereby preventing circuits within the light source device 200 from being disconnected. Conversely, when the detected impedance is lower than the pre-set value, the impedance controller 145 may increase the impedance of the variable impedance unit 133 to prevent a current having a value equal to or greater than an allowable value from being introduced to the triac TR. Also, a reactance component of the impedance of the light source device 200 and the light source driving apparatus 103 may also be removed.

To this end, the impedance controller 145 may include an impedance measurement unit 141 for detecting impedance of the light source driving apparatus 103 and the light source device 200, an A/D converter 142 for converting a result value from the impedance measurement unit 141 into a digital signal, and a central processing unit (CPU) 143 for outputting a control signal for varying the impedance of the variable impedance unit 133 upon receiving the digital signal from the A/D converter 142. Here, the control signal output by the CPU 143 may be delivered to respective switches S_{L1}, S_{L2}, S_{L3}, S_{C1}, S_{C2}, and S_{C3} of the variable impedance unit 133, and the impedance of the variable impedance unit 133 may be changed according to an ON/OFF operation of the switches S_{L1}, S_{L2}, S_{L3}, S_{C1}, S_{C2}, and S_{C3}. The switches S_{L1}, S_{L2}, S_{L3}, S_{C1}, S_{C2}, and S_{C3} may be transistor elements such as a metal oxide silicon field effect transistor (MOSFET), a bipolar junction transistor (BJT), or the like.

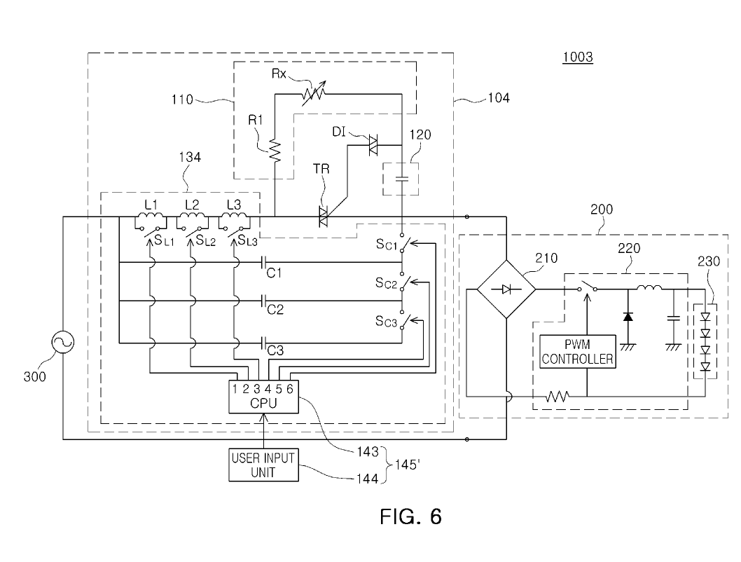

FIG. 6 is a circuit diagram illustrating a light source driving apparatus 104 and a light source system 1003 according to a modification to the embodiment of FIG. 5.

An impedance controller 145′ according to an embodiment of the present inventive concept may be understood as an element for controlling impedance of the variable impedance unit 134 based on a user input. To this end, the impedance controller 145′ may include a user input unit 144 for receiving a user input and a CPU 143 for outputting a control signal for varying the impedance of the variable impedance unit 134 upon receiving an output signal from the user input unit 144.

The user input unit 144 may receive inputs corresponding to respective impedance values that may be implemented by the variable impedance unit 134 from a user. For example, when the variable impedance unit 134 includes N number of inductors connected in series, N number of switches connected to the inductors in parallel, respectively, M number of capacitors connected in parallel, and M number of switches connected to the capacitors in series, respectively, maximum impedance values that may be implemented by the variable impedance unit 134 may be 2^{N}(M+1). Here, the user input unit 144 may selectively receive any one of the 2^{N}(M+1) number of input values from the user.

According to an embodiment of the present inventive concept, the light source driving apparatus 104 capable of exhibiting optimal optical quality and providing a high degree of freedom to a user, and the light source system 1003 having the light source driving apparatus 104 can be provided.

Hereinafter, A lighting apparatus will be described in detail. The lighting apparatus may include the light source device 200 and 201 employable in the light source system 1000, 1001, 1002 and 1003 according to an embodiment of the present inventive concept.

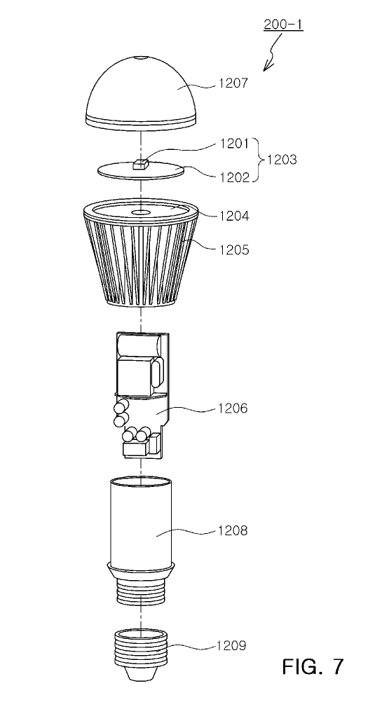

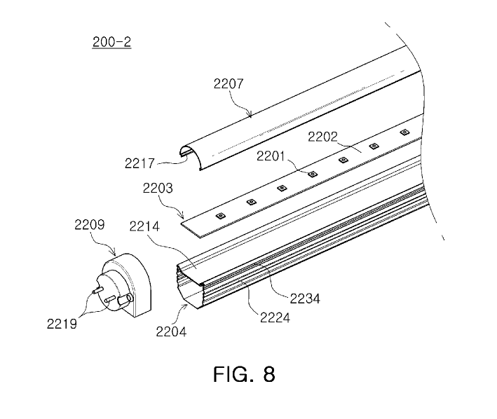

FIGS. 7 and 8 are exploded perspective views illustrating lighting apparatus 200-1 and 200-2 employable in a light source system according to an embodiment of the present inventive concept.

The lighting apparatus 200-1 may be a bulb-type lamp as illustrated in FIG. 7. The lighting apparatus 200-1 may have a shape similar to a shape of a light bulb which may replace a conventional light bulb (e.g., an incandescent lamp), and may output light having optical characteristics (color, color temperature, and the like) similar to optical characteristics of a light bulb, but the present inventive concept is not limited thereto.

Referring to the exploded perspective view of FIG. 7, the lighting apparatus 200-1 may include a light emitting module 1203, a driving unit 1206, and an external connection unit 1209. The lighting apparatus 200-1 may further include external and internal housings 1205 and 1208 and an outside structure such as a cover unit 1207. The light emitting module 1203 may include a light source 1201 and a circuit board 1202 on which the light source 1201 is mounted. In the embodiment of FIG. 7, a single light source 1201 is illustrated as being mounted on the circuit board 1202, but if necessary, a plurality of light sources may be installed. Here, the light source 1201 may be an LED.

In the lighting apparatus 200-1, the light emitting module 1203 may include the external housing 1205 acting as a heat dissipation unit. The external housing 1205 may include a heat dissipation plate 1204 in direct contact with the light emitting module 1203 to enhance a heat dissipation effect. Also, the lighting apparatus 200-1 may include the cover unit 1207 installed on top of the light emitting module 1203 and having a convex lens-like shape. The driving unit 1206 may be installed in the internal housing 1208 to receive power from the external connection unit 1209 such as a socket structure. Also, the driving unit 1206 may serve to convert power into an appropriate current source for driving the light source 1201 of the light emitting module 1203, and provide the same. The driving unit 1206 may include a rectifier (e.g., 210 in FIG. 1) and a DC/DC converter (e.g., 220 in FIG. 1).

The lighting apparatus 200-2 may be a bar-type lamp as illustrated in FIG. 8. The lighting apparatus 200-2 may have a shape similar to a fluorescent lamp which may replace a conventional fluorescent lamp, and may output light having optical characteristics similar to optical characteristics of a fluorescent lamp, but the present inventive concept is not limited thereto. In particular, illumination using discharge such as a conventional fluorescent lamp is difficult for dimming control, but according to an embodiment of the present inventive concept, a light source system having high compatibility with a dimming-controllable light source driving apparatus and having characteristics (a shape, optical characteristics, and the like) similar to characteristics of a fluorescent lamp can be obtained.

Referring to the exploded perspective view of FIG. 8, the lighting apparatus 200-2 according to an embodiment of the present inventive concept may include a light source module 2203, a body unit 2004, and a terminal unit 2209. The light source module 2203 may further include a cover unit 2207 covering the light source module 2203.

The light source module 2203 may include a substrate 2202 and a plurality of light sources 2201 installed on the substrate 2202. Here, the light source 2201 may be an LED.

The body unit 2204 may allow the light source module 220 to be fixed on one surface thereof. The body unit 2204, a type of support structure, may include a heat sink. The body unit 2204 may be made of a material having excellent heat conductivity to dissipate heat generated by the light source module 2203 outwardly. For example, the body unit 2204 may be made of a metal, but the present inventive concept is not limited thereto.

The body unit 2204 may have an overall extended bar-like shape corresponding to the shape of the substrate 2202 of the light source module 2203. A recess 2214 may be formed on one surface of the body unit 2204 to accommodate the light source module 2203 therein. The light source module 2203 may be installed in the recess 2214.

A plurality of heat dissipation fins 2224 for dissipating heat may be formed on and protrud from both outer surfaces of the body unit 2204. Stoppage grooves 2234 may be formed in both ends of the outer surface of the body unit 2204 positioned to be higher than the recess 2214. The stoppage grooves 2234 may extend in a length direction of the body unit 2204. The cover unit 2207 as described hereinafter may be fastened to the stoppage grooves 2234.

Both end portions of the body unit 2204 in the length direction may be open, so the body unit 2204 may have a pipe structure in which both end portions are open. In the embodiment of FIG. 8, the body unit 2204 is illustrated to have the structure in which at least one end portions thereof are open, but the present inventive concept is not limited thereto. For example, any one of both end portions of the body unit 2204 may be open.

The terminal unit 2209 may be provided in at least one open side of both end portions of the body unit 2204 in the length direction to supply power to the light emitting module 2203. In the embodiment of FIG. 8, it is illustrated that at least one end portions of the body unit 2204 are open and the terminal unit 2209 is provided in at least one end portions of the body unit 2204. However, the present inventive concept is not limited thereto and, in the case of a structure in which only one side is open, the terminal unit 2209 may be provided in only one opened side of both end portions.

The terminal unit 2209 may be fastened to both open end portions of the body unit 2204 to cover the both open end portions. The terminal unit 2209 may include electrode pins 2219 protruding outwardly.

The cover unit 2207 may be fastened to the body unit 2204 to cover the light source module 2203. The cover unit 2207 may be made of a material allowing light to be transmitted therethrough.

The cover unit 2207 may have a semicircular curved surface allowing light to be uniformly irradiated to the outside overall. The cover unit 2207 may have a protrusion 2207 formed on the bottom thereof fastened to the body unit 2204 in a length direction of the cover unit 2207. The protrusion 2217 may be engaged with the stoppage groove 2234 of the body unit 2204.

In the embodiment of FIG. 8, the cover unit 2207 is illustrated to have a semicircular shape, but the present inventive concept is not limited thereto. For example, the cover unit 2207 may have a flat quadrangular shape or may have any other polygonal shape. The shape of the cover unit 2207 may be variously modified according to a design of illumination for irradiating light.

As set forth above, according to an embodiment of the present inventive concept, the light source driving apparatus having high compatibility with the light source device including LEDs can be obtained.

According to an embodiment of the present inventive concept, a light source system in which compatibility between the light source device and the light source driving apparatus is improved and in which flicker phenomenon is alleviated can be obtained.

Advantages and effects of the present inventive concept are not limited to the foregoing content and any other technical effects not mentioned herein may be easily understood by a person skilled in the art from the foregoing description.

While the present inventive concept has been shown and described in connection with the embodiments, it will be apparent to those skilled in the art that modifications and variations can be made without departing from the spirit and scope of the inventive concept as defined by the appended claims.

What is claimed is:

1. A light source driving apparatus, comprising:
a triac configured to control a phase of an output voltage;
a diac connected to a gate of the triac and configured to apply a trigger signal;
a voltage charger configured to provide a breakover voltage to the diac;
a variable resistor unit configured to determine a point in time at which the voltage charger provides a breakover voltage; and
a variable impedance unit connected to both ends of the triac and including a capacitor and an inductor, the variable impedance unit being configured to vary its impedance.

2. The light source driving apparatus of claim 1, wherein the variable impedance unit comprises:
at least one capacitor, and a first switch connected to the at least one capacitor in series, and
at least one inductor, and a second switch connected to the at least one inductor in parallel.

3. The light source driving apparatus of claim 2, further comprising an impedance controller configured to:
detect impedance of the light source driving apparatus and a light source device connected to the light source driving apparatus, and
vary impedance of the variable impedance unit.

4. The light source driving apparatus of claim 3, wherein the impedance controller comprises:
an A/D converter configured to convert the detected impedance into a digital signal; and
a control processing unit (CPU) configured to output a control signal for varying impedance of the variable impedance unit upon receiving the digital signal.

5. The light source driving apparatus of claim 4, wherein the first and second switches are switched ON/OFF based on the control signal outputted from the CPU.

6. The light source driving apparatus of claim 3, wherein:
when the detected impedance is lower than a pre-set value, the impedance controller is configured to increase impedance of the variable impedance unit, and
when the detected impedance is higher than the pre-set value, the impedance controller is configured to reduce impedance of the variable impedance unit.

7. The light source driving apparatus of claim 1, wherein the variable impedance unit comprises:
a plurality of capacitors connected in parallel; and
a plurality of switches connected to the plurality of capacitors in series, respectively.

8. The light source driving apparatus of claim 1, wherein the variable impedance unit comprises:
a plurality of inductors connected in series; and
a plurality of switches connected to the plurality of inductors in parallel, respectively.

9. The light source driving apparatus of claim 1, wherein the variable resistor unit comprises a fixed resistor element, and a variable resistor element connected to the fixed resistor element in series.

10. The light source driving apparatus of claim 9, wherein the variable resistor unit comprises a dimming removal switch connected to the variable resistor element in parallel.

11. A light source system, comprising:
a light source device including a light emitting diode (LED); and
a light source driving apparatus configured to provide a phase-controlled voltage to the light source device, and vary impedance of the light source driving apparatus by changing at least one of capacitance and inductance.

12. The light source system of claim 11, wherein the light source driving apparatus comprises:
a variable impedance unit including at least one capacitor and a switch connected to the at least one capacitor in series, at least one inductor and a switch connected to the at least one inductor in parallel.

13. The light source system of claim 12, wherein the light source driving apparatus further comprises:
an impedance controller configured to detect impedance of the light source driving apparatus and the light source device, and vary impedance of the variable impedance unit.

14. The light source system of claim 13, wherein:
when the detected impedance is lower than a pre-set value, the impedance controller is configured to increase impedance of the variable impedance unit, and
when the detected impedance is higher than the pre-set value, the impedance controller is configured to reduce impedance of the variable impedance unit.

15. The light source system of claim 11, wherein the light source device comprises:
a rectifier configured to rectify a phase-controlled voltage provided from the light source driving apparatus;
a DC/DC converter configured to convert a magnitude of the rectified voltage; and
a light emitting diode (LED) driven by a voltage having the converted magnitude.

16. The light source driving apparatus of claim 1, wherein the variable impedance unit comprises:
two or more capacitors, and at least one switch connected to the two or more capacitor in series, and
two or more inductors, and two or more switches connected to the two or more inductors in parallel, respectively.

17. A light source driving apparatus, comprising:
a triac configured to control a phase of an output voltage; and
a variable impedance unit connected to both ends of the triac and including:
two or more capacitors, and at least one switch connected to the two or more capacitors in series, and
two or more inductors, and two or more switches connected to the two or more inductors in parallel, respectively,
wherein the variable impedance unit is configured to vary its impedance.

18. The light source driving apparatus of claim 17, further comprising a diac connected to a gate of the triac and configured to apply a trigger signal,
Wherein the triac is turned on, upon receiving the trigger signal from the gate of the triac, and then power from an external power source is applied to a light source device through the triac.

19. The light source driving apparatus of claim 18, further comprising a voltage charger configured to provide a breakover voltage to the diac.

20. The light source driving apparatus of claim 17, further comprising a variable resistor unit configured to determine a point in time at which the voltage charger provides a breakover voltage.
